(19) United States
(12) Patent Application Publication
(10) Pub. No.: US 2019/0043130 A1
(43) Pub. Date: Feb. 7, 2019

(54) System and Method for Processing Data Sets

(71) Applicant: Turing Technology Advisors, Inc., White Salmon, WA (US)

(72) Inventors: Vadim Fishman, White Salmon, WA (US); Alexey Panchekha, White Salmon, WA (US)

(21) Appl. No.: 16/052,924

(22) Filed: Aug. 2, 2018

Related U.S. Application Data
(60) Provisional application No. 62/541,633, filed on Aug. 4, 2017.

(51) Int. Cl. G06Q 40/06; G06F 3/06

(52) U.S. Cl. CPC G06Q 40/06; G06F 3/067; G06F 3/0653; G06F 3/0604

(57) ABSTRACT

The invention relates to a method and a system for reconstructing composition or attributes of financial portfolios using incomplete information. Aspects provide improved evolution of a portfolio position, which may be time varying. Other aspects include minimization of the deviations from the natural economic evolution of the composition in the absence of external forces for a portfolio under a constraint on return difference between an actual and a reconstructed portfolio, which can be based on directly observable parameters.

### RELATED APPLICATIONS

This application claims the benefit of and priority to U.S. Provisional Application No. 62/541,633, filed on Aug. 4, 2017, entitled “Reconstructing Composition of Financial Portfolios Using Incomplete Information”, which is hereby incorporated by reference.

### TECHNICAL FIELD

The present disclosure relates to systems and methods having a machine learning engine, processing circuits and other hardware and software adapted to handle, process and format original sets of data or other signals and to apply a performance metrics and rules thereto, and to output a different reconstructed set of data or signals conforming to said metrics and rules to mimic or approximate at least some features of the historical data set.

### BACKGROUND

Common financial products exist in the form of portfolios. A portfolio is a composite of financial instruments (e.g. stocks, bonds, futures, ETFs, etc.) the composition and value of which may vary in time. It may be desirable to reconstruct a portfolio composition at a point in time, the past, or at the current moment to gain an understanding of the portfolio's nature, dynamics, to create an effective hedging (forward-looking) portfolio, as well as to access current portfolio makeup.

Portfolio composition and its evolution in time are typically modeled using key factors and expressed as a linear model. Such representation is coarse, reducing hundreds of individual instruments to a few factors. It is a challenge to mimic, reconstruct or otherwise duplicate or approximate the characteristics of a portfolio and/or its composition in terms of underlying instruments to be able to hedge the same in variable market conditions.

Traditional methods are based on using Return Deviation to minimize Tracking Error. Return Deviation is a point-in-time difference between the actual portfolio returns and the reconstructed portfolio returns. The Tracking Error is a statistical measure of Return Deviation, aggregated through observations. Existing methods differ by a specific form of the objective function concerned with minimizing Tracking Error, the optimization procedure employed to carry out the minimization, and supplementary objective functions may be added to improve the results.

Traditional methods are limited and flawed as a result of the minimization of the Tracking Error being used as the objective of the methods. The Tracking Error taken as a sole objective results in overfitting, instability of the portfolio holdings and other undesired behavior that runs against economic nature of financial portfolios. As a result, supplementary objective functions are often added to remedy this situation.

Adding supplementary objectives introduces other problems. With multiple objectives, it is necessary to assign relative weights to each objective. Such relative weights have no grounding in economic nature of the portfolios. They cannot be observed in a natural life-cycle of a financial portfolio. Therefore, an artificial step, often called calibration, becomes a part the process.

Therefore, since prior methods were solely focused on explaining past behavior, prior methods focused on minimizing Tracking Error. Prior methods did not consider the unstable effects of hedging out of sample. This results in contrived or unstable results and/or artificial steps required to define non-observable parameters.

### SUMMARY

In view of the above limitations of prior methods, there is a need for a system and method to reconstruct portfolio holdings that is based on the economic nature of the portfolio being reconstructed and which is free or as free from non-observable parameters as possible.

In an aspect, the invention provides a method and a system for reconstructing a time-varying composition of multiple holdings in the context of hedging a financial portfolio. This concept can also be applied to other problems aside from financial portfolio analysis and hedging. For example, those skilled in the art will appreciate that it could be useful to reconstruct or predict or otherwise hedge generalized original data sets in various scientific, economic, social, and engineering problems. This invention describes these approaches with preferred or exemplary embodiments directed to financial portfolio data sets, but as mentioned, this system and method can be applied to other examples without loss of generality. Aspects of the present disclosure are based on economically sensible principles native to the portfolios; the system and method works with actual underlying instruments and are not based on minimization of Tracking Errors. This technique is free or as free as possible from non-observable parameters. This new system and method is therefore applicable to a wide set of financial and other problems. A key distinction here is the ability to perform forward-looking operations and generate forward-looking output (signals, data) rather than being limited to backward-looking solutions as is the case in prior approaches.

The method and the system of this invention comprehend the natural dynamics of a financial portfolio. A portfolio has a natural economic evolution of its composition in the absence of external factors that compel a manager of the portfolio to undertake reactive or proactive actions. As an example, a portfolio that is constantly rebalanced to fixed weights will have zero difference in its weights through time. A buy-and-hold equity portfolio will have constant shares of stocks invested through time. Even though the invented method can be used for the purpose of exposure modeling, the invention is best understood and illustrated here through reconstructing time-varying portfolio composition in terms of underlying instruments.

We refer to the natural economic evolution of composition of a portfolio in the absence of external forces or factors a Portfolio Inertia Process. It is different for portfolios of different nature but it can be defined and considered pre-determined, it is based on known factors rather than on unknown external events.

Portfolio Inertia Process may be expressed in a simple mathematical form in the case of a portfolio with constant weights or constant shares. It may be expressed in a more complex mathematical form when portfolio includes bonds, commodities, or options.

In some embodiments, a reconstruction method is based on an objective function comprising minimization of deviations from the Portfolio Inertia Process. For example, in the case of a constant weights portfolio, the objective function may be described as

min [Σₜ₌₀^{N}Sqr(ωₜⁱ−ωₜ₊₁ⁱ)]

where Sqr( ) denotes the power of two.

The manager's actions are reflected through a constraint on Return Deviation, which can be limited by an upper and/or lower thresholds at any moment in time.

The present method and system for executing the present method differ from traditional (Tracking Error minimization) approaches in a number of ways. For example, in some present embodiments, the Return Deviation is not aggregated in any way. Rather, the present method may constrain the maximum positive and the minimum negative values observed at any individual moment in time. Additionally, the Return Deviation of the present method may not be compared (aggregated or not) with the objective of minimizing deviations from the Portfolio Inertia Process. Furthermore, the threshold values can be observed directly by running the same system historically through known data. Alternatively, it can be also reasoned through the nature of the portfolio being reconstructed.

Again, the examples provided in the context of hedging financial portfolios with individual holdings is applicable to other scientific, engineering and social and economic problems using the present system and method where an original data set, signals and policy inputs is used as presently described to generate a reconstructed data set, output signals, or results.

A portfolio typically follows some policy rules like a budget constraint or a hedging policy. These policy rules are naturally expressed as additional constraints. Disclosures of full or partial holdings information are treated in this invention as hard or soft constraints at the point in time that the disclosure pertains to. Market events like corporate actions can also be included through constraints. In the following sections, we describe this system and method in further detail and illustrate them with exemplary embodiments.

Some embodiments are directed to automated system for receiving original inputs and parameters, and generating reconstructed outputs corresponding to the original inputs, the system including a processing circuit; a data communication interface, coupled to said processing circuit, the data communication interface comprising circuitry comprising a communication port thereof, coupling said system to a data communication network, and configured and arranged to receive signals encoding original data from an external source over said network via said communication port; a data store, coupled to said processing circuit, the data store comprising a plurality of addressable data storage locations, configured and arranged to receive signals representative of said original data and to retain an electronic representation of the same that is accessible by addressing a selected group of said addressable storage locations; and an instruction store, coupled to said processing circuit, the instruction store comprising a plurality of addressable instruction storage locations, configured and arranged to retain an instruction set determining steps of operation of said system, including steps to act on said original data to generate reconstructed data, the instruction store further comprising a plurality of addressable instruction storage locations encoding machine-readable instructions which executed by said processing circuit minimize an aggregate measure of deviation between said original data and said reconstructed data.

Other embodiments are directed to a method for minimizing a deviation of a reconstructed data set in a processor-based system, comprising receiving an original data set representing an original data set from a source of original data, including point-in-time data regarding said original data set; defining a plurality of encoded rules to generate a reconstructed data set comprising a plurality of individual parts thereof; determining an objective function comprising a data-set-inertia of said reconstructed data set; determining an aggregate measure of deviation between the original and reconstructed data sets based on said objective function; and minimizing the aggregate deviation by adding or deleting individual parts from said reconstructed data set.

### BRIEF DESCRIPTION OF THE DRAWINGS

For a fuller understanding of the nature and advantages of the present invention, reference is made to the following detailed description of preferred embodiments and in connection with the accompanying drawings, in which:

FIG. 1 illustrates an exemplary system according to the present disclosure, which may be adapted to other instances without loss of generality;

FIG. 2 is an illustration of an exemplary method following the present disclosure, with main processes shown in the context of a portfolio process; and

FIG. 3 is an illustration of a Return Deviation and constraint.

### DETAILED DESCRIPTION

The method and the system of this invention consider portfolio natural dynamics. Every portfolio has a natural evolution of the composition of its holdings in the absence of external forces that compel a manager of the portfolio to undertake reactive or proactive actions. The following are examples of such process for specific financial portfolios, and are intended by way of illustration of preferred features of the invention, which are not to be limiting thereof.

A portfolio that is constantly rebalanced to fixed weights has zero difference in its weights through time, or

ωₜⁱ−ωₜ₊₁ⁱ=0

where ωₜⁱ is the weight in i-th asset at time t. ωₜ₊₁ⁱ denotes the same value in the next moment of time.

A buy-and-hold equity portfolio will have constant shares of stocks invested through time, or

sₜⁱ−sₜ₊₁ⁱ=0

where sₜⁱ is the shares in i-th stock at time t. sₜ₊₁ⁱ denotes the same value in the next moment of time.

A buy-and-hold bond portfolio will have the same notional exposure in bonds, which are predictively aging day by day, or

nₜⁱ(M)−nₜ₊₁ⁱ(M−Δt)=0

where nₜⁱ(M) is the notional exposure in the i-th bond with maturity M at time t. And nₜ₊₁ⁱ(M−Δt) denotes the same value in the next moment of time, with maturity M reduced by the same amount of time Δt. Maturity M is also representative of other time-dependent elements of a bond definition like a call provision or an amortization schedule.

A commodity portfolio will have the same number of commodity contracts that age day by day in predictable manner which are also being sold and replaced (rolled) according to a known expiration schedule, or

Cₜⁱ(Eⁱ)−{Cₜ₊₁ⁱ(Eⁱ−Δt)|Cₜ₊₁^{j}(E^{j})}=0

where Cₜⁱ(Eⁱ) is the number of i-th commodity contracts at time t with time to expiration Eⁱ. {Cₜ₊₁ⁱ(Eⁱ−Δt)|Cₜ₊₁^{j}(Eⁱ)} denotes the same contracts Cₜ₊₁ⁱ(Eⁱ−Δt) in the next moment of time, with time to expiration reduced by the same amount of time Δt or a new contract Cₜ₊₁^{j}(E^{j}) in the same commodity with a new expiration date E^{j}. Replacement of expiring contracts Cₜ₊₁ⁱ(Eⁱ) with new ones Cₜ₊₁^{j}(E^{j}) is often referred to as rolling.

Those skilled in the art will understand that the foregoing examples can be generalized and extended to other instances as suitable for a given application, and therefore the examples provided are not intended to be limiting of the scope of this invention.

We described the natural economic evolution of the composition of holdings in the absence of external forces or factors as Portfolio Inertia Process. It is different for portfolios of different nature but it can be proscribed in a given instance and/or be pre-determined. In an aspect, this attribute it is not based on unknown external events or parameters.

The present reconstruction method is based on one objective function—minimization of an aggregate measure of deviations from the Portfolio Inertia Process. For example, in the case of a constant weights portfolio the objective function may be

min [Σₜ₌₀^{N}|ωₜⁱ−ωₜ₊₁ⁱ|]

or

min [Σₜ₌₀^{M}Sqr(ωₜⁱ−ωₜ₊₁ⁱ)]

or

min [Σₜ₌₀^{N}F(ωₜⁱ−ωₜ₊₁ⁱ)]

where ∥ denotes an absolute value, Sqr( ) denotes a power of two, and F( ) denotes a suitable weight function.

A general representation of the objective function may be expressed as

min [Σₜ₌₀^{N}F(PiP)]

where PiP is a mathematical expression for the Portfolio Inertia Process.

The Return Deviation represents manager's reaction in response or in anticipation of external events. In some embodiments, the present reconstruction method may be based on limiting the maximum and/or minimum value of the Return Deviation by an upper and/or lower threshold, respectively, at a given moment in time, or

RD(t)=R(t)−Σᵢ₌₁^{N}rᵢ(t)

Th⁻<=RD(t)<=Th⁺

where RD(t) is the Return Deviation at time t calculated as a difference between the actual portfolio return R(t) and the sum of the contribution to the return from all positions in the reconstructed portfolio rᵢ(t). Th⁺ and Th⁻ are the limits for the Return Deviation values at any moment of time. Th⁺ typically has a positive value and Th⁻ typically has a negative value. Th⁺ and Th⁻ may have the same absolute values, but this is not necessary in the present system and method.

In some embodiments, that Return Deviation is generally suitable for any financial portfolio. However, it may be replaced by a different temporal profitability measure if a different portfolio's profitability measure is applicable to the portfolio.

It can be appreciated that in various embodiments, the present system and method is based on minimizing a deviation from the Portfolio Inertia Process and limiting Return Deviation treated independently rather than on minimizing the Tracking Error as in the conventional methods.

We provide next an exemplary and non-limiting example of the application of the present system and method, which as stated apply to many general physical and engineering and economic problems.

One example embodiment reflects an Equity Portfolio that is regularly or constantly rebalanced to fixed weights. Returns of each equity (stock) is at a series or sequence of times t, most typically for all days the market was open during the period of time T. Returns on the portfolio are also known for the same moments of time.

One goal of the present technique and system is to reconstruct the weights δₜ for each equity position in the portfolio for each moment of time. The optimization problem reflects this process in the mathematical form:

$$L = \frac{1}{2} {\sum }_{i = 1}^{n} {\sum }_{t = 2}^{T - 1} {( {β}_{t}^{i} - {β}_{t - 1}^{i} )}^{2} -> {min}_{{β}_{t}^{i}} \\ {R}_{t} - {\sum }_{i = 1}^{n} {β}_{t - 1}^{i} {r}_{t}^{i} \leq {ɛ}_{up} ∀ t = 2 , … , T$$

$${R}_{t} - {\sum }_{i = 1}^{n} {β}_{t - 1}^{i} {r}_{t}^{i} \geq - {ɛ}_{low} ∀ t = 2 , … , T$$

$${β}_{1}^{i} = {c}^{i}$$

$${β}_{t}^{i} \geq 0$$

$${\sum }_{i = 1}^{n} {β}_{t}^{i} = 1$$

This can be described as a process. We minimize the change of the weights βₜⁱ over time (denoted by L). We constrain return deviations between the actual Portfolio Rₜ and its reconstruction Σᵢ₌₁ⁿrₜⁱ, setting upper and lower limits ∈ᵤₚ,∈_{low}. The point-in-time constraint δ₁ⁱ=cⁱ represents reported full portfolio holdings attributed to the first moment of time t=1. The last two constraints represent common portfolio policy constraints: long only positions and no leverage correspondingly. The subscript t represents time that spans values from 1 to N. The subscript i represents a holding within the portfolio. The total number of holdings is n.

In this embodiment, we employ matrix representation of the mathematical objects defined above. The concatenation of all weights βₜⁱ becomes a vector β:

β=(βₜ¹,βₜ², . . . ,βₜⁿ).

The minimization objective L can be implemented as a matrix as well:

$$\frac{1}{2} {\sum }_{i = 1}^{n} {\sum }_{t = 2}^{T - 1} {( {β}_{t}^{i} - {β}_{t - 1}^{i} )}^{2} = \frac{1}{2} {\sum }_{i = 1}^{n} {\sum }_{t = 2}^{T - 1} {( {β}_{t}^{i} )}^{2} - 2 {β}_{t}^{i} {β}_{t - 1}^{i} + {( {β}_{t - 1}^{i} )}^{2}$$

Every βₜⁱ is going to be encountered at this sum twice except for the terms with t=1, t=T−1. We can write L explicitly as a matrix multiplication in the following form ½β^{T}Qβ. To understand the structure of the matrix Q, consider the case of T=4, n=3. Vector β in this case has the length of 9, and Q will be 9 by 9 matrix of a specific structure shown below

$$Q = ( \begin{matrix}1 & 0 & 0 & 1 & 0 & 0 & 0 & 0 & 0 \\ 0 & 1 & 0 & 0 & 1 & 0 & 0 & 0 & 0 \\ 0 & 0 & 1 & 0 & 0 & 1 & 0 & 0 & 0 \\ 1 & 0 & 0 & 2 & 0 & 0 & 1 & 0 & 0 \\ 0 & 1 & 0 & 0 & 2 & 0 & 0 & 1 & 0 \\ 0 & 0 & 1 & 0 & 0 & 2 & 0 & 0 & 1 \\ 0 & 0 & 0 & 1 & 0 & 0 & 1 & 0 & 0 \\ 0 & 0 & 0 & 0 & 1 & 0 & 0 & 1 & 0 \\ 0 & 0 & 0 & 0 & 0 & 1 & 0 & 0 & 1\end{matrix} )$$

Constraints on the maximum and minimum values for the return deviation take the form Gβ≤k. Following the same example of T=4, n=3, matrixes G,k will take the following form

$$G = ( \begin{matrix}0 & 0 & 0 & - 1 & 0 & 0 & 0 & 0 & 0 \\ 0 & 0 & 0 & 0 & - 1 & 0 & 0 & 0 & 0 \\ … & & & & & & & & \\ 0 & 0 & 0 & r \frac{1}{2} & r \frac{2}{2} & r \frac{3}{2} & 0 & 0 & 0 \\ 0 & 0 & 0 & - r \frac{1}{2} & - r \frac{2}{2} & - r \frac{3}{2} & 0 & 0 & 0 \\ 0 & 0 & 0 & r \frac{1}{3} & r \frac{2}{3} & r \frac{3}{3} & 0 & 0 & 0 \\ 0 & 0 & 0 & - r \frac{1}{3} & - r \frac{2}{3} & - r \frac{3}{3} & 0 & 0 & 0\end{matrix} )$$

$$k = ( \begin{matrix}0 \\ 0 \\ ⋮ \\ {R}_{3} + {ɛ}_{low} \\ - {R}_{3} + {ɛ}_{up} \\ {R}_{4} + {ɛ}_{low} \\ - {R}_{4} + {ɛ}_{up}\end{matrix} )$$

Finally, the point-in-time constraint for the reported holdings and portfolio policy rules can be represented in the form Aβ=b, where matrix A has the following form

$$( \begin{matrix}1 & 0 & … & & & & & \\ 0 & 1 & 0 & … & & & & \\ ⋮ & & & & & & & \\ 1 & 1 & 1 & 0 & 0 & 0 & 0 & … \\ 0 & 0 & 0 & 1 & 1 & 1 & 0 & …\end{matrix} )$$

We have thus completed conversion of all objects into a matrix from. With this conversion in place, we observe that the problem as stated conforms to a quadratic optimization specification and can be solved by a number of off-the-self optimization modules allowing sufficiently large matrixes.

The above examples, being non-limiting and in an illustrative context, are implemented in processor-based systems comprising a plurality of component devices or modules or sub-systems as is presented herein. The representations provided here are to be understood to apply to physical quantities, signals, voltages, currents, or other tangible representations that can be managed by a machine or processor-based apparatus (herein a system).

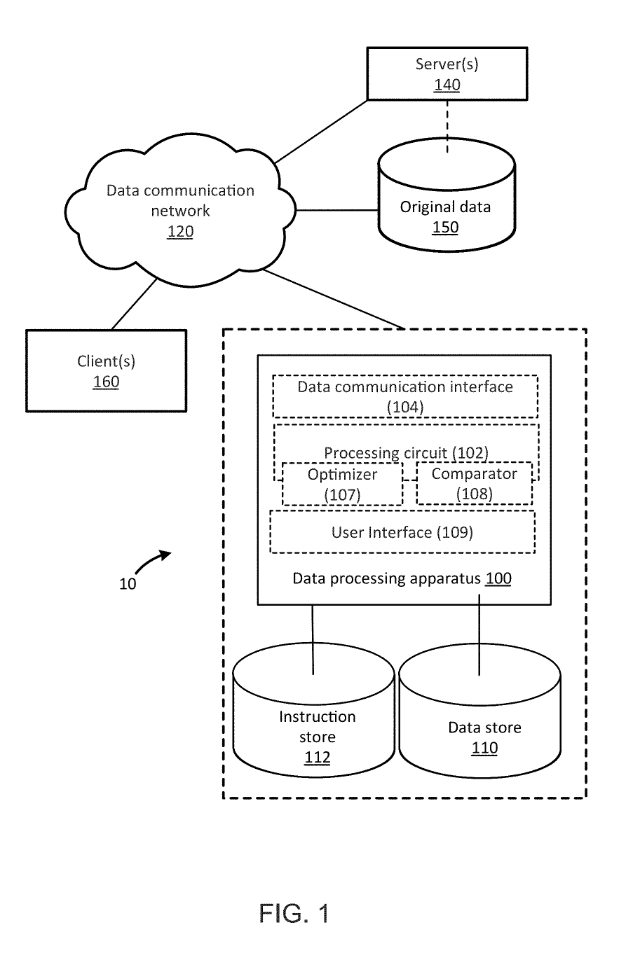

FIG. 1 illustrates a representation of an exemplary architecture of a portfolio reconstruction system 10 according to an embodiment of this invention and shows some basic elements thereof. Those skilled in the art will appreciate that variations and equivalent embodiments are also possible, which can be modified within the present scope to a particular application. Also, the elements as shown can be adapted for implementation in a re-arranged form or by combining two or more illustrated elements into a single element, or by dividing one shown element into a subset of equivalent elements as best suits a given situation.

The system 10 of FIG. 1 may comprise one or more processing circuits configured and arranged and further coupled to elements of the system to receive, process and output signals representing information, data or machine-readable instructions. The machine-readable instructions may further be organized into logical sets that are executed on or by said processing circuits and that cause operation of said system in the manner presently prescribed. Preferably, the system 10 comprises one or more processing or logic modules or engines, each logical module or engine having a primary logical function within the system and which may be co-operated to achieve the overall functions described herein.

The system 10 can include or comprise a data processing apparatus 100, which may be a server, computer, mobile or fixed processing device, smart phone or distributed processing entity. The data processing apparatus may include a central processing circuit or several processors coupled as necessary by one or more system communication buses. The data processing apparatus 100 and processing circuit(s) 102 can be employed to receive, process, and output signals or data representative of parameters and objects as used herein. Also, a communications engine or module having a data communication interface 104 can be employed to send or receive wired or wireless signals so as to exchange data with other systems, networks, remote data stores, servers or clients. The data communication interface 104 may comprise hardware circuitry, processing microelectronics, firmware, software and so on to execute and implement any suitable communication protocol over a communication medium. The communication protocol can include an Internet communication protocol, and the system may be adapted to compress, encrypt, de-compress and/or de-crypt signals received or sent by said communication engine or module.

A data communication network 120 is used to couple system 10 with other systems, servers 140, devices, client(s) 160 and users such as an original data source 150, which may provide original data directly to system 10 or indirectly over a communication channel such as the Internet or data communication network 120.

The processing circuit 102 or module can then determine quantitative aspects such as the above-described Return Deviation, Portfolio Inertia, and other useful parameters and functions. The processing engines or modules may thus output or provide signals and data representative of a reproduced portfolio that are a function of various parameters and data from the actual portfolio.

A feature extractor module or engine may be incorporated within or coupled to said system, or to a processing core of said system. The feature extractor module or engine comprising hardware and/or software configured and arranged or programmed so that when executing machine-readable instructions in a compatible processing circuit cause the extraction of required features from data or signals available to said module or engine. In an example, the extraction engine or module determines return deviation from extracted information provided to the extraction module.

The system may also comprise one or more data stores or memory units such as a volatile and/or non-volatile memory device configured and arranged to store data, program instructions or signals representative of information used in the present method. The data stores can be unified or separated and coupled to one another or to the system's processing modules as suitable and understood to those skilled in the art, including by way of on-system data communication methods such as techniques and protocols and hardware components to transfer data to and from said memory units in an appropriate form.

Conceptually, the flow of signals, data or information may include inputs and/or outputs from the perspective of the overall system or components, engines and modules thereof.

In an aspect, the input information, data or signals include or represent returns of an actual portfolio and returns of potential holdings of the reconstructed portfolio reported holdings of the actual portfolio (full or partial) additional reported holding information corporate actions other events.

As will be further described below, the system 10 collectively takes signals and data representative of attributes of an actual financial portfolio, for example the actual financial portfolio's current and/or historical composition, performance, or constituents, which may be provided to the system over the above-described communication interface.

The system 10 can take in a number of different types of information.

In a first example, the system accepts point-in-time conditions that can describe the composition of an original portfolio or fund. The point-in-time conditions are generally not published very frequently by the managers of the original portfolio or fund, and may only be provided on a monthly or quarterly basis. This point-in-time data may be in the form of a prospectus that lists the number of shares or percentage holdings of individual positions in a portfolio or fund. Since funds are dynamic and undergoing trading on a regular basis (buying and selling various positions) it is not possible for outsiders other than the fund managers to know at each given time the exact composition of the fund or portfolio. In an aspect, the present system and method solve the problem of trying to reconstruct such a fund or portfolio in the absence of real-time or frequent data regarding the composition of the fund. So the system can determine original fund compositions and other original data about the original portfolio or fund if and when such point-in-time data are made available.

In a second example, the system receives regular pricing data from a source of the same, e.g., a source that publishes daily stock prices for various components of a portfolio. So for the reconstructed portfolio or fund, the system can determine a daily (or even hourly) value and other parameters of the reconstructed fund or portfolio based on the information obtained from one or more pricing data feed(s).

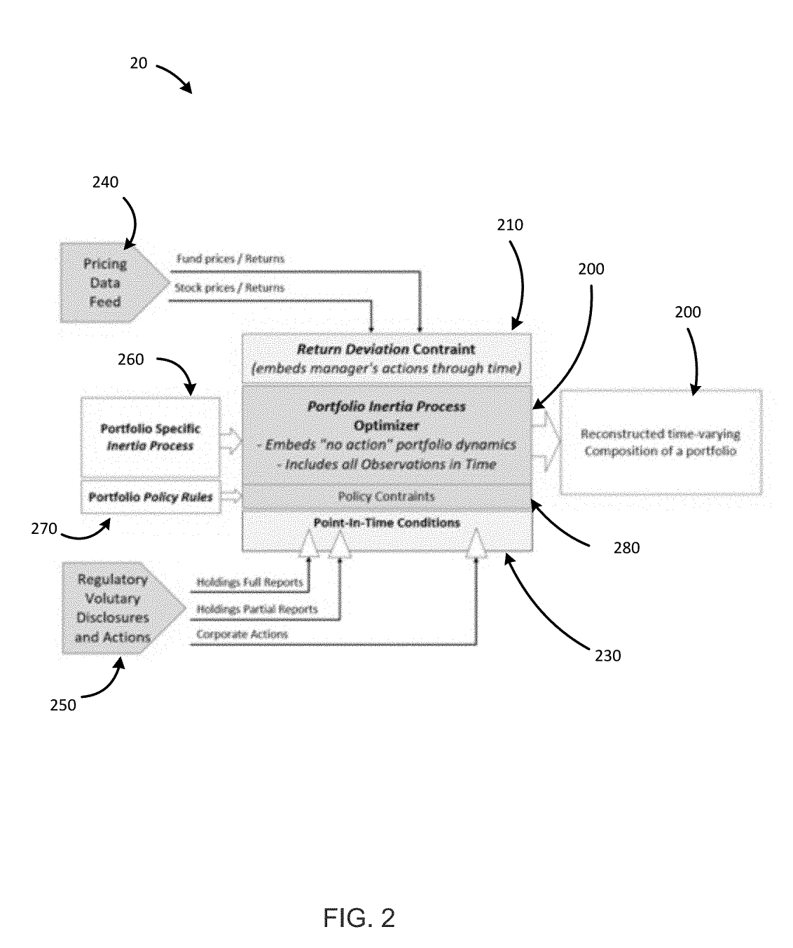

FIG. 2 illustrates an exemplary method or process 20 according to an example of the present invention. As mentioned before, data and information are input to the present system, which acts on the data and information accordingly, and provides useful outputs based thereon.

Disclosures by an original fund manager are provided from time to time as point-in-time conditions reflecting for example the composition of positions within the original fund of interest. In particular, a prospectus may be published as required by a regulatory agency or on a voluntary basis. The prospectus of the original fund can include the constituent positions held at the time of publication of the prospectus. For example, the prospectus can include a table showing the percentage of the total fund in each position, the number of such shares, etc.

One or more pricing data feeds 240 provide pricing information regarding each holding of the reconstructed fund, which can be used to compute various performance metrics of the reconstructed fund and to determine its return deviation with respect to the original fund of interest.

The portfolio specific inertia process 260 is factored into the portfolio inertia process optimizer 200, and is presently for example a minimization of an objective function (e.g., return deviation) as described above. Also, any portfolio policy rules 270 of the original portfolio or fund are used in the present system and method to better constrain its operation. Note that the present method and system allow for policy constraints of the reconstructed portfolio or fund as well. For example, the original portfolio may have natural or artificial policy rules, for example that the original fund manager only deals in domestic stocks, or that the fund will not trade in war zone stocks, or that the fund leans towards investments in environmentally-conscious companies, or that the fund is limited to large cap stocks, and so on. Similar policies can be adopted by or avoided in the reconstructed fund or portfolio as determined by the fund's manager or as desired by the fund's customers, encoded into the policy constraints module 280.

It should be understood that the behavior of the original and reconstructed funds is a dynamic matter and that some or all aspects of the funds can be time-variable. This is comprehended by the present invention, which looks to the future behavior of the system, unlike most prior systems that are concerned with duplicating past performance of a target fund. By analogy, the present system can extrapolate to future performance and return metrics as opposed to systems that are only concerned with interpolation onto historical data and which cannot generate a desired future outcome.

The Optimization block of FIG. 2 embeds the Portfolio Inertia Process and a suitable method to minimize its value. Simple form of the Portfolio Inertia Process applicable to many portfolios simplifies optimization process, which can often be carried out by of-the-shelf modules.

Returns of the actual portfolio and returns of potential holdings are known with some regularity and span some time interval. Using an equity mutual fund as an example, the returns of the fund as well as returns of the stocks are usually known for each day when market was open.

This information is fed into the module that calculates Return Deviation between the actual portfolio and a potential reconstructed portfolio at each moment of time and compares it with thresholds Th⁺ and Th⁻.

Reported holdings of the portfolio are known infrequently. For a mutual fund, holdings are generally reported on quarterly basis to a Regulator with some delay. Holding data is fed into the module that constrains reconstructed holdings to match reported ones for the day of reporting either exactly or with some tolerance.

It is also a common practice for fund managers to disclose partial holdings at will. For example, a fund manager may report taking or closing a significant position in a company. This information may be also fed into constraints for a single security or a few securities at the time of disclosure.

Corporate events are mergers, acquisitions, splits, and other life-cycle transitions. They affect underlying securities. Such events are represented as point-in-time constraints that link related securities through the event, or reflect a typical manager's reaction to such event.

Other events are included as well. For example, a bond can be called or defaulted. In this invention, various moment-in-time events are naturally handled through a fixed or soft constraint affective at the time of the event. Specific form of treatment of corporate events and other events does not constitute the nature of the invention.

In general, we portray three major parts of the system as they process different kinds of information:

Natural evolution in time of the portfolio composition in the absence of external events is represented by the optimization module so as to minimize deviations from the Portfolio Inertia Process.

A flow of management's decisions that cause deviations from the Portfolio Inertia Process is processed though the constraining Return Deviation. In some embodiments, other portfolio policies and events are added as suitable to their nature.

The thresholds for Return Deviation can be established independently on their own merits. For example, by direct observations over the past or by standalone considerations rooted in the portfolio nature.

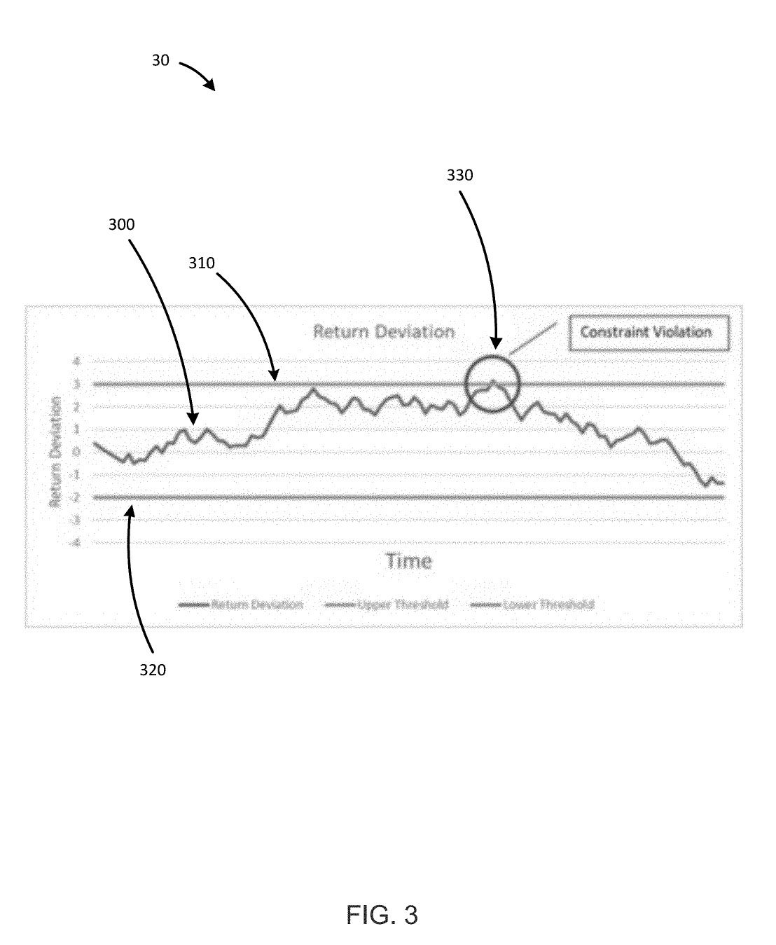

FIG. 3 illustrates an exemplary plot 30 of the reconstructed return fund or portfolio deviation output signal and/or data as generated by the present system and method. The time-varying return deviation 300 can be tracked and minimized according to an objective function, and according to the dynamic inertia described herein. Positive and negative thresholds as discussed above (310, 320) can be defined for bounding the return deviation 300. Exceeding one of the thresholds can constitute a constraint violation as shown at 330, in which case a corrective action or communication signal can be taken.

It is to be appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. Variations and modifications of the embodiments described herein, which would occur to persons skilled in the art upon reading the foregoing description, are contemplated by and included in this disclosure.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein. The present materials, methods, and examples are illustrative only and not intended to be limiting.

What is claimed is:

1. An automated system for receiving original inputs and parameters, and generating reconstructed outputs corresponding to the original inputs, the system comprising:
a processing circuit;
a data communication interface, coupled to said processing circuit, the data communication interface comprising circuitry comprising a communication port thereof, coupling said system to a data communication network, and configured and arranged to receive signals encoding original data from an external source over said network via said communication port;
a data store, coupled to said processing circuit, the data store comprising a plurality of addressable data storage locations, configured and arranged to receive signals representative of said original data and to retain an electronic representation of the same that is accessible by addressing a selected group of said addressable storage locations;
an instruction store, coupled to said processing circuit, the instruction store comprising a plurality of addressable instruction storage locations, configured and arranged to retain an instruction set determining steps of operation of said system, including steps to act on said original data to generate reconstructed data, the instruction store further comprising a plurality of addressable instruction storage locations encoding machine-readable instructions which executed by said processing circuit minimize an aggregate measure of deviation between said original data and said reconstructed data.

2. The system of claim 1, said plurality of addressable instruction storage locations encoding machine-readable instructions which executed by said processing circuit minimize an aggregate measure of deviation between from a portfolio inertia parameter encoded into a data signal stored in said data store and processed by said processing circuit.

3. The system of claim 2, further comprising an optimization module acting along with said processing circuit, configured and arranged to minimize said deviation.

4. The system of claim 1, further comprising said processing circuit further comprising a comparator that compares said deviation to a pre-encoded threshold value and outputs a signal indicative of whether the deviation is greater or is not greater than said pre-encoded threshold value.

5. The system of claim 1, further comprising machine-readable instructions which executed by said processing circuit cause said system to read one or more constraint signals encoded into said data store and to take steps as a function of said constraint signals.

6. The system of claim 5, said constraint signals comprising encoded signals received from a market data source, over said data communication network and the data communication interface.

7. A method for minimizing a deviation of a reconstructed data set in a processor-based system, comprising:
receiving an original data set representing an original data set from a source of original data, including point-in-time data regarding said original data set;
defining a plurality of encoded rules to generate a reconstructed data set comprising a plurality of individual parts thereof;
determining an objective function comprising a data-set-inertia of said reconstructed data set;
determining an aggregate measure of deviation between the original and reconstructed data sets based on said objective function; and
minimizing the aggregate deviation by adding or deleting individual parts from said reconstructed data set.

8. The method of claim 8, said data sets comprising portfolios and said individual parts thereof comprising holdings, wherein said minimizing optimizes a future hedging performance of said system.
